(19) United States
(12) Patent Application Publication
(10) Pub. No.: US 2007/0139199 A1
(43) Pub. Date: Jun. 21, 2007

(54) Method and apparatus for an active radio frequency identification tag

(75) Inventor: Bart A. Hanlon, Still River, MA (US)

Correspondence Address: WOLF GREENFIELD & SACKS, P.C., 600 ATLANTIC AVENUE, BOSTON, MA, 02210-2206, US

(73) Assignee: PanGo Networks, Inc., Framingham, MA (US)

(21) Appl. No.: 11/606,409

(22) Filed: Nov. 29, 2006

Related U.S. Application Data
(60) Provisional application No. 60/740,568, filed on Nov. 29, 2005.

(51) Int. Cl. G08B 13/14; G08B 1/08

(52) U.S. Cl. 340/572.1; 340/539.13

(57) ABSTRACT

In on aspect, a dual mode radio frequency identification (RFID) tag adapted to facilitate location determination in a network is provided. The RFID tag comprises a transceiver adapted to wirelessly exchange information with the network, and a controller coupled to the transceiver, the controller configurable to operate the RFID tag in one of a plurality of modes, wherein, in a first mode of the plurality of modes, the controller is configured to transmit a chirp to the network via the transceiver to be used by at least one network component to determine a location of the RFID tag, and wherein, in a second mode of the plurality of modes, the controller is adapted to process information received from the network via the transceiver to compute a location of the RFID tag.

### RELATED APPLICATIONS

This application claims priority under 35 U.S.C. §119(e) to U.S. Provisional Application Ser. No. 60/740568, entitled “METHOD AND APPARATUS FOR A RADIO FREQUENCY IDENTIFICATION TAG,” filed on Nov. 29, 2005, which is herein incorporated by reference in its entirety.

### FIELD OF INVENTION

The present invention relates to location-aware networks, and more particularly, to location determination of a wireless network client such as a radio frequency identification (RFID) tag in a wireless network environment.

### BACKGROUND

Aspects of many enterprise operations may benefit from an ability to determine the location of objects of interest within a specified area or region. Examples include, but are not limited to, tracking inventory, locating assets or personnel, providing location specific content or media, etc. The proliferation of wireless local area networks (LAN) has enabled many enterprises, such as corporations, businesses and other organizations to capitalize on location tracking technology. In particular, an enterprise's existing wireless LAN infrastructure may be used to implement systems for locating, tracking and/or monitoring assets in a wireless LAN environment.

The term “asset” refers herein to any object whose location may be of interest, including, but not limited to, articles of manufacture, wholesale or retail inventory, medical devices, manufacturing equipment, information technology (IT) equipment, containers, personnel or any other object for which location tracking and/or monitoring may be desirable. In some instances, the asset itself may be network-aware, that is, the asset itself may be adapted to communicate with a wireless network. Examples of network aware assets may include laptop computers, cellular telephones, personal digital assistants (PDA's), hand held devices, etc. In some instances, the asset for which tracking is desired may not itself be network-aware. For example, a variety of articles of manufacture, inventory, human personnel, etc., may have limited or no ability to communicate with a network.

To enable location determination of such assets, a radio frequency identification (RFID) tag may be affixed to the asset to relay location information about the asset to the network. For example, an enterprise having a large and generally mobile inventory of objects may affix an RFID tag to desired objects to keep track of where particular inventory is currently located. Hospitals, for instance, often have extensive equipment that may be moved from place to place to service patients in different rooms, departments, etc. It may be important to know where such equipment is located to respond to emergencies or otherwise effectively service patients and efficiently provide staff with the equipment they need. RFID tags may also be affixed to personnel to track the location of, for example, security, doctors, nursing staff or other employees of an enterprise who may need to be located.

In general, an RFID tag communicates with access points (or specialized sensors) distributed in a wireless network environment. Characteristics of the communication are analyzed to determine the location of the tag. Many techniques are available for determining location. For example, the time delay of arrival (TDOA), time of arrival (TOA), or the angle of arrival (AOA) of a communication from the tag at each of the access points within range may be used to determine the location of the tag. In addition, obtaining radio signal strength indicators (RSSI), often referred to as RF fingerprinting, may be used to determine the location of the RFID tag. In particular, the signal strength of the transmission from the tag at the various access points may be used to determine the location of the tag within the network environment.

### SUMMARY OF THE INVENTION

Some embodiments according to the present invention include a dual mode radio frequency identification (RFID) tag adapted to facilitate location determination in a network, the RFID tag comprising a transceiver adapted to wirelessly exchange information with the network, and a controller coupled to the transceiver, the controller configurable to operate the RFID tag in one of a plurality of modes, wherein, in a first mode of the plurality of modes, the controller is configured to transmit a chirp to the network via the transceiver to be used by at least one network component to determine a location of the RFID tag, and wherein, in a second mode of the plurality of modes, the controller is adapted to process information received from the network via the transceiver to compute a location of the RFID tag.

Some embodiments according to the present invention include an 802.11 compliant radio frequency identification (RFID) tag adapted to facilitate location determination in a network environment, the RFID tag comprising a transceiver adapted to wirelessly transmit information to the network, and a controller coupled to the transceiver, the controller adapted to transmit a chirp via the transceiver, to be used by at least one network component to determine, at least in part, a location of the RFID tag, wherein the controller is configured to transmit the chirp as an 802.11 management frame.

Some embodiments according to the present invention include a configurable radio frequency identification (RFID) tag to facilitate location determination in a network, the RFID tag comprising a transceiver adapted to wirelessly exchange information with the network, and a controller coupled to the transceiver, the controller adapted to provide location information from which a location of the RFID tag may be determined, the controller configured to receive configuration information from at least one network component connected to the network and to configure at least one operating parameter of the RFID tag based on the configuration information.

### BRIEF DESCRIPTION OF DRAWINGS

FIG. 1 is a diagram illustrating a location-aware wireless local area network (LAN) servicing a plurality of network clients, in accordance with some embodiments of the invention;

FIG. 2 is a schematic diagram illustrating a radio frequency identification (RFID) tag to facilitate location determination in a wireless network environment, in accordance with some embodiments of the invention;

FIG. 3 is a schematic diagram illustrating a radio frequency identification (RFID) tag to facilitate location determination in a wireless network environment, in accordance with some embodiments of the invention; and

FIG. 4 is a schematic diagram illustrating a radio frequency identification (RFID) tag to facilitate location determination in a wireless network environment, in accordance with some embodiments of the invention.

### DETAILED DESCRIPTION

As discussed above, an enterprise may benefit in a variety of ways from a location-aware network, for example, asset tracking, location dependent content distribution, etc. However, implementing a location-aware network has conventionally required adding relatively extensive specialized equipment to the network and/or making specialized modifications to the existing network infrastructure. Conventional tracking systems often require a separate network of readers, antennas and other wireless infrastructure to be purchased and installed to enable location-awareness in the network. For example, many conventional tracking systems require at least specialized sensors to be installed to communicate with the network-aware client (e.g., one or more network aware RFID tags). Other systems require modification to wireless LAN access points, for example, by applying a filter overlay such that communications from network clients can be recognized and appropriately processed.

Applicant has appreciated that the widespread use of wireless local area networks (LAN) provides the opportunity to implement relatively low cost location determination capabilities to enable a location-aware wireless LAN. In particular, Applicant has appreciated that providing network aware clients (e.g., network aware RFID tags) that are compatible with one or more network standards permits location determination facilities to be implemented with little or no modification to existing wireless LAN infrastructure, reducing or eliminating additional costs to acquire, install and maintain specialized location-aware infrastructure.

In one embodiment according to the present invention, an RFID tag is adapted to provide location information compatible with the IEEE 802.11 network communication standard. For example, the RFID tag may be configured to transmit location information using one or more of the 802.11 management frames defined by the 802.11 specification, the various versions of which are herein incorporated by reference in their entirety. For example, the RFID tag may transmit location determination information as an 802.11 probe request. The term “location information” refers herein to any information communicated between a network client and the network from which one or more properties, characteristics and/or measurements are obtained to facilitate determining the location of the network client. In general, and unless otherwise stated, communicating with the network refers to transferring information between a network client and one or more devices connected to the network or devices comprising the network infrastructure (e.g., access points, switches, hubs, network servers, etc.).

The widespread use of wireless LANs has also produced a relatively significant variety in the type of wireless LANs that are installed. Applicant has appreciated that providing an RFID tag having a plurality of configurable modes facilitates relatively simple integration of the RFID tag in a variety of different wireless LAN types. For example, having recognized the benefits of tracking capabilities, some wireless LAN vendors provide infrastructure (e.g., wireless network access points, one or more low level software programs, etc.) that is, at least to some extent, location-aware. For example, an infrastructure vendor may provide network access points configured to recognize certain enabled clients and, in some cases, measure the signal strength of transmissions from the client to facilitate determining its location, and/or the infrastructure vendor may provide a location-aware application coupled to the network to compute measurements from signals received by the access points. However, other infrastructure vendors provide no such capabilities. In such environments, location information may be obtained by the network client, for example, by obtaining RSSI measurements from signals transmitted by the various access points in the network. Conventional network clients (e.g., conventional RFID tags) work in one environment or the other, but not both.

Applicant has appreciated that providing an RFID tag configurable to operate in a plurality of modes permits the RFID tag to be useable in a more comprehensive set of wireless network environments. In one embodiment, an RFID tag is provided that, when operating in a first mode, transmits information to a plurality of network access points, which either alone or in combination with one or more applications and/or devices connected to the network, determine the location of the tag from the information. When operating in a second mode, the RFID tag receives signals from a plurality of network access points and obtains location information from the received signals. In another embodiment, the mode in which the RFID tag operates may be selected and configured via the wireless network. For example, configuration information that instructs which mode the RFID tag should operate in may be provided by an application and/or device communicating over the wireless network. The RFID tag may be adapted to recognize the instruction and, as a result, operate in the selected mode.

Following below are more detailed descriptions of various concepts related to, and embodiments of, methods and apparatus according to the present invention. It should be appreciated that various aspects of the inventions described herein may be implemented in any of numerous ways. Examples of specific implementations are provided herein for illustrative purposes only.

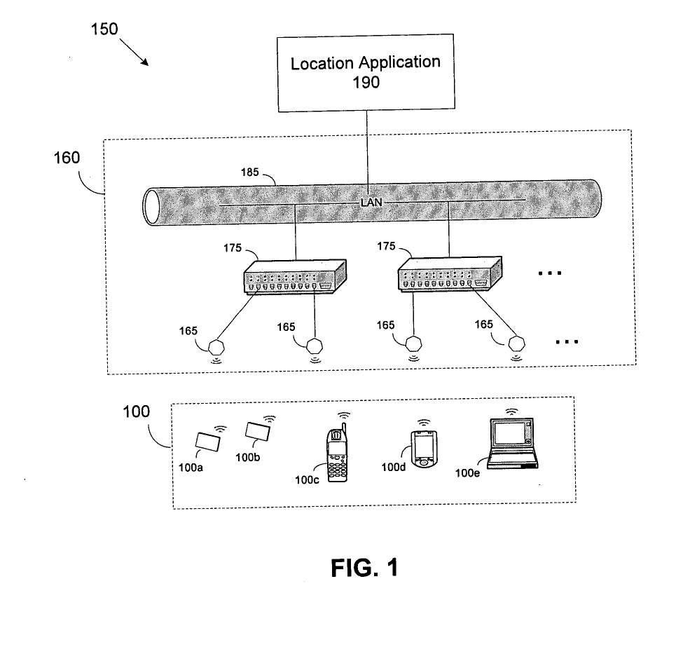

FIG. 1 illustrates an exemplary location-aware wireless LAN, in accordance with one embodiment of the present invention. Wireless LAN 150 includes a number of network clients 100. For example, wireless LAN 150 may service network clients including any one or combination of RFID tags 100a and 100b, cellular telephone 100c, PDA 100d, and laptop computer 100e. The wireless LAN includes network infrastructure 160 having a plurality of access points 165 to relay wireless signals to network switches 175, which in turn direct information over the physical LAN connections 185. Also coupled to the LAN may be one or more location applications 190 that determine the location of one or more network clients and/or performs various location determination tasks. For example, location application 190 may include an asset tracking application that employs location information to display the location of network clients on a user interface, such as displaying an icon of the various clients on a plan or map of the space or area that the wireless LAN services.

As discussed above, there are several general modes in which a location-aware wireless network may operate. In a first mode, the network infrastructure may implement, to varying extents, some portion of the location determination capabilities. In this mode, the access points may operate as readers, receiving transmissions from the clients from which location information is extracted. In some instances, location application 190 may be provided by the network infrastructure vendor and may include functionality to extract location information and/or determine location from the signals received at the access points. In addition, the access points themselves may include some level of location-awareness. For example, the access points may compute one or more measurements (e.g., RSSI, TDOA, TOA, AOA, etc.) of received transmissions and relay this location information to other resources to determine the location of the respective network client. It should be appreciated that the manner in which the network implements location-awareness is not a limitation on the various aspects of the invention.

The IEEE 802.11 standard has gained industry acceptance and relatively widespread implementation and use in wireless LANs. The term 802.11 network refers generically to any network conforming to and/or interoperable with the IEEE 802.11 standard for wireless LAN technology, including versions 802.11b and 802.11g and its progeny, and version 802.11a for accelerated communications. Present versions and new versions to be released in the future are designed to be backwards compatible, and therefore all versions will be referred to generically as 802.11 to indicate compatibility with the standard in general. Any device capable of communicating in accordance with at least one version, for example, the 802.11b/g family and its progeny, may be considered 802.11 compatible. The term Wireless Fidelity (Wi-Fi®) refers to 802.11 networks and/or devices that have been certified as 802.11 compliant according to interoperability tests performed by the Wi-Fi Alliance.

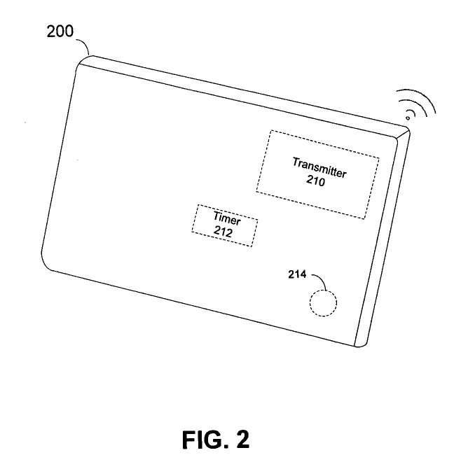

FIG. 2 illustrates an 802.11 compatible RFID tag, in accordance with one embodiment of the present invention. The term RFID tag refers herein to any device capable of transmitting radio frequency signals and that can, to some extent and in some fashion, identify itself (e.g., via a unique identifier). Generally, an RFID tag is designed to be coupled or affixed to, or otherwise associated with another object whose location is of interest. RFID tag 200 includes a transmitter 210 adapted to transmit signals recognizable by an 802.11 wireless LAN. Transmitter 210 may include a processor and an antenna, or may include any other combination of integrated circuits, discrete components, and/or other electronics capable of transmitting a wireless signal, as the aspects of the invention are not limited in this respect.

RFID tag 200 may be a network client such as RFID tags 100a and 100b illustrated in FIG. 1, adapted to be affixed to an asset for which tracking is desired. RFID may include any type of affixing means such as adhesive, hook and latch, tie wrap, clip, etc. RFID 200 may be adapted to connect to a key chain (key fob) or designed to be placed in the pocket of personnel. It should be appreciated that RFID tag may be of any shape or size and may have any type (or none) of affixing means, as the aspects of the invention are not limited in this respect.

In one embodiment, wireless LAN 150 illustrated in FIG. 1 is an 802.11 (e.g., Wi-Fi®) location-aware network. As discussed above, in one mode of operation, a wireless network client broadcasts a signal which is received by one or more access points that are within range. The access points (or other components coupled to the access points and/or connected to the network, such as location application 190) process the broadcast to determine the location of the device (e.g., by obtaining RSSI information from the broadcast, or computing TDOA, TOA and/or AOA values, etc.). The broadcast from a wireless enabled client (e.g., RFID tag 200) from which location information is obtained, and/or location determination is at least partially based, is referred to herein as a chirp.

RFID tag 200 may operate by transmitting a chirp periodically according to a designated time interval, which may be configured to be of any desired duration. For example, RFID may include a timer 212 that can be configured to store a programmable time interval which, upon expiration, signals the transmitter to emit a chirp. Upon emitting the chirp, the timer may be restarted and count down again before signaling the transmitter to emit the subsequent chirp. Some applications may benefit from real-time or near real time asset tracking, or may be sensitive to time critical monitoring. Such applications may benefit from a relatively short interval such that the location of the tag can be tracked at a rate suitable for the application.

For example, the RFID tag 200 may be configured to chirp every second or on a sub-second time schedule. Other exemplary applications may not need such up-to-date information and may choose a longer interval, for example, every minute, ten minutes, hourly, etc. It should be appreciated that the RFID tag may be configured to chirp at any rate and according to any desired time schedule, as the aspects of the invention are not limited in this respect.

Alternatively, or in addition to the configurable time interval, chirps emitted from RFID tag 200 may be triggered by other events. For example, RFID tag 100 may include a motion sensor 214 adapted to detect when the RFID tag is in motion. The motion sensor enables the RFID tag 200 to chirp more frequently (or only) when the tag is moving to facilitate accurate up-to-date tracking. Otherwise, when the tag is motionless, the tag may not need to chirp as frequently (or at all) and may remain relatively dormant, thus conserving battery power.

A motion sensor may also be used in connection with a configurable time interval to allow different chirp rates depending on whether the tag is in motion or not. For example, when the tag is stationary, a relatively long timer interval (i.e., a relatively long delay between chirps) may be sufficient to track the tag. However, when the tag is in motion, the timer interval may be decreased to facilitate more rapid location updates as the tag moves about the environment. For example, when the tag is mobile, real-time or near real-time location updates may be desired, while when stationary, frequent updates may be unnecessary. It should be appreciated that any event may be used to trigger a chirp, which may be configurable and/or employed alone or in combination with one or more other events, as the aspects of the invention are not limited in this respect.

RFID tag 200 may be configured to chirp using standard 802.11 frames. The 802.11 standard defines a number of frame types that Wi-Fi® or other 802.11 compliant clients use to communicate over the wireless LAN. 802.11 frames are commonly categorized in one of a number of different frame types, which include: 1) management frames; 2) control frames; and 3) data frames. As will be understood by those of ordinary skill in the art, the various versions of the 802.11 specification fully describe the format and use of the various frame types, and will not be described in detail herein.

RFID tag 200 may, for example, emit a chirp as one of the standard 802.11 management frames recognizable by the 802.11 network. One or more devices comprising the network may then process the chirp to extract location information from the chirp and/or determine the location of the tag based on the chirp. Since the network is 802.11 compliant, it is already configured to recognize and process standard 802.11 management frames, so additional hardware overlay or other specialized equipment may be unnecessary. For example, the 802.11 management chirps emitted by RFID tag 200 may be received by one or more access points (e.g., access points 165) and transferred to location application 190 to determine the location of the tag. RSSI measurements, for instance, may be extracted from the chirp to determine the location of the RFID tag.

In one embodiment, the 802.11 chirp emitted by RFID tag 200 is a probe request frame. As a general matter, a probe request frame may be used by a network client to obtain information from another network device. For example, a network client may send a probe request frame to determine which access points in the wireless LAN are within range. In general, access points (or other 802.11 stations) that receive the probe request respond with a probe response frame, containing capability information, supported data rates, etc.

The 802.11 probe request frame transmitted by RFID tag 100 may be used as a transmission from which location information is extracted, for example, by access points 165, alone or in combination with location application 190, or any other device coupled to the network. In particular, RSSI (or TDOA, TOA, AOA, etc.) measurements may be extracted from the probe request to facilitate determining the location of the RFID tag. RFID tag 200 need not be adapted to receive the probe response frame, though, in some embodiments the probe response is processed by RFID tag 200. Since RFID tag 200 chirps using standard 802.11 management frames (e.g., an 802.11 probe request), specialized sensors, filters, and/or hardware overlays may not be required for the RFID tag to be recognized, thus facilitating relatively simple and cost effective implementation in the wireless LAN.

The operation of transmitting a probe request (and optionally receiving the probe response) can be performed quickly and with relatively little power with respect to engaging in full network connectivity (e.g., performing a full network association). That is, many conventional RFID tags require fully establishing a network connection to communicate information, and more particularly, to communicate location information to the network. This action requires additional power, bandwidth and complexity. Accordingly, providing an 802.11 probe request chirp may simplify the process of providing location information, preserve bandwidth, and conserve battery power, thus lengthening the time in which the RFID tag can be deployed without having to replace the batteries.

For example, RFID tag 200 may be adapted to operate in a low power mode (referred to as sleep mode) in between chirps. When one or more events trigger the tag to emit a chirp (e.g., the expiration of the configured time interval, motion of the tag, or some other event), the tag wakes up, transmits one or more 802.11 probe request chirps, and then returns to sleep mode, thus conserving battery power. In addition, the probe request uses relatively little bandwidth, such that network performance may be negligibly affected.

It should be appreciated that other types of broadcasts may be performed, as the aspects of the invention are not limited in this respect. In particular, RFID tag 200 may chirp using other 802.11 management frames, for example, an 802.11 action frame, beacon frame and/or an association request frame. The type of frame with which the RFID tag chirps may be configurable, as discussed in further detail below.

An 802.11 association request instructs an access point to allocate resources for and synchronize with an 802.11 client, for example, RFID tag 200. Typically, the 802.11 client begins the association process by sending an association request to an access point. The association request carries information about the client (e.g., supported data rates) and the network it wishes to associate with. In some embodiments, RFID tag 200 emits an association request chirp from which location information is extracted to facilitate determining the location of the tag. However, association is a longer and more computation expensive operation then performing a probe request/response. As such, in some embodiments, it may be advantageous to enable the RFID tag to emit 802.11 probe requests to provided location information to the network.

In general, the association request is employed to engage and initiate communication with one or more devices connected to the network. After receiving an association request, a receiving access point(s) considers associating with the client that sent the association request, and (if accepted) reserves memory space and establishes an association identification for the requesting client. The access point then sends an association response frame containing an acceptance or rejection notice to the 802.11 client requesting association. If the access point accepts, the association response frame includes information regarding the association, such as an association identification, supported data rates, etc. If the outcome of the association is positive, the client can utilize the access point to communicate with other devices on the network.

In some embodiments, transmitter 210 may be a transceiver adapted to both transmit and receive communications over the network. As discussed above, a probe request does not require a full association with the network. As a result, the information exchange in a probe request/response may be generally limited. In some embodiments, RFID tag 200 may periodically exchange information with the network by performing an association with one or more access points that are within range to initiate full network connectivity. For example, in addition to transmitting a chirp to facilitate location determination, RFID tag 200 may periodically connect with the network to exchange information that cannot readily be transmitted in the chirp.

In embodiments that include periodic network connectivity, the frequency at which the tag connects to the network may be configurable, but is preferably performed less frequently than the chirp. The interval of time between connecting to the network is referred to herein as the association interval when describing a Wi-Fi® and/or 802.11 network environment. By setting the association interval to be long with respect to the chirp interval, the speed and power savings of the relatively simple chirp can be leveraged, while enabling the tag to communicate with the network at regular, though perhaps, less frequent intervals. It should be appreciated, however, that an association interval may be set to any length, as the aspects of the invention are not limited in this respect. Moreover, network association may be triggered by any number of events, such as by a timer, motion sensor, battery low alert, etc.

Periodically connecting to the network provides for an RFID tag that can be configured during operation. In particular, configuration information may be exchanged between the network and the tag when the tag associates with the network. For example, the chirp interval may be re-configured to change and/or set the tag to operate at a desired chirp rate. Similarly, the association interval can be configured as desired to, for example, connect to the network once an hour, once a day, once a week, according to a particular trigger event, or according to any other method suitable for a particular asset tracking application. Any of various other parameters and/or operating characteristics of the RFID tag may also be configured when the tag associates or otherwise establishes a connection with the network, as the aspects of the invention are not limited in this respect. In addition, once associated, the tag may communicate state information about the environment of the asset to which the tag is associated. State information may include environmental parameters such as temperature, humidity, shock and/or operating status or asset disposition, as discussed in further detail below.

As discussed above, some network infrastructure vendors provide network equipment that is, to some extent, location-aware. For example, access points (or software and/or hardware connected to the network) may be adapted to receive location information from clients connected to the network (e.g., by recognizing a client chirp). However, the various network infrastructure vendors may differ with respect to the manner in which a client communicates location information to the network. That is, location-awareness may be implemented differently from network to network.

RFID tag 200 may be configured to chirp according to the expectations of the network environment in which the tag is deployed. In particular, RFID tag may be configured to operate in any of a plurality of chirp modes for which the tag has been adapted. For example, to be compatible with a variety of 802.11 networks, RFID tag 100 may be adapted to chirp according to a number of different 802.11 frames. In one embodiment, RFID tag 100 is capable of chirping using a plurality of selectable 802.11 management frames. The type of management frame used as the chirp may be configured at the tag itself and/or over the network (e.g., during an interval in which the tag connects to the network), to comply with the expectation of the network.

Accordingly, when operating in an 802.11 network that recognizes 802.11 probe requests for the purpose of location determination, RFID tag may be configured to transmit probe request chirps. Similarly, when operating in an 802.11 network that recognizes 802.11 action frames to transmit location information, RFID tag 200 may be configured to chirp using one or more action frames. It should be appreciated that RFID tag 200 may be adapted to transmit any one or combination of 802.11 frames and be configurable such that any desired chirp mode may be selected. In addition, other non-802.11 chirp modes may be used and selectively configured, as the aspects of the invention are not limited in this respect.

The channels over which a chirp is transmitted may also be configured. For example, an RFID tag may default to broadcasting a chirp on channels 1, 6 and 11 (non-overlapping channels) in the 802.11 frequency band. However, a given network may prefer or expect the RFID tag to chirp over a different channel or set of channels. The network may instruct RFID tag 200 to chirp over the desired or expected channels, for example, during a period when the RFID tag associates or otherwise connects with the network. Other broadcast characteristics and/or parameters may also be configured, as the aspects of the invention are not limited in this respect.

In addition, other parameters may be configured during periods of network connectivity. For example, whether the RFID tag chirps based on a motion detector, periodic interval (or both) may be configured according to instructions transmitted by one or more devices operating on the network. Location application 190, for instance, may expose a user interface that allows the operator to select the personality of the RFID tag. That is, the user interface may allow a user to configure one or more properties, characteristics and/or operating modes of the RFID tag, such as chirp rate and chirp type, association rate, trigger event type, etc. The RFID tag may also transmit information about its own environment to the network upon association with the network. For example, the RFID tag may report a battery low condition during a network connectivity interval to alert the network or operator monitoring the tag that the battery may need to be replaced.

As discussed above, RFID tags may be used to track assets or personnel that are not themselves wireless network enabled, or are otherwise incapable of communicating location information. In many applications, the environment and/or characteristics of the asset being tracked may be important. Accordingly, RFID tag 100 may be adapted to report on various environmental conditions and/or communicate one or more operating characteristics of the asset to which the tag is associated. For example, RFID tag may include one or more sensors to detect desired environmental conditions such as temperature, motion (e.g., vibration), humidity, etc. RFID tag 100 may provide sensor measurements, status reports and/or other information corresponding to the asset environment. In addition, RFID tag 100 may be adapted to detect and report when the tag has been separated from the associated asset to prevent, for example, theft or unintentional removal of the asset from a designated area.

In some embodiments, RFID tag 200 includes one or more communication ports adapted to connect to electronic assets, such as IT assets, medical equipment, etc., and report one or more properties, parameters and/or operating characteristics of the asset. For example, RFID tag 200 may include a serial port that can connect to the serial port of the asset. The asset may communicate information about its operation, environment, etc., which information can in turn be relayed to the network by the tag during a communication interval.

For example, a electronic asset such as a medical device may communicate diagnostic information over the communication port to the RFID tag to alert personnel to a malfunction and/or to report that the medical device is operating correctly. Likewise, information may be transmitted from the network to the electronic asset via the link between the electronic asset and the communication port. The electronic asset may be instructed to turn off, power up, operate in a different mode, perform some action, etc. It should be appreciated that any communication port may used, such as serial communication, Universal Serial Bus (USB), IEEE-1394 (FireWire), infrared (IrDA), etc., as the aspects of the invention are not limited in this respect.

It should be appreciated that RFID tag 200 may include any one or combination of the features described above and is not required to include any particular one or set of features. The above descriptions merely provide illustrative concepts and features that an RFID tag, according to various aspects of the present invention, may include either alone or in any combination. Moreover, the various aspects of the invention may be applied to any network client and are not limited for use in an RFID tag or any particular network client discussed herein.

As discussed above, some networks implement some level of network awareness. In location-aware network environments, network clients may transmit information to the network and the network infrastructure (e.g., access points) performs one or more computations to determine the location of the device. In this first mode of operation, the network client itself may not include hardware and/or software components configured to determine the clients location, relying instead on the network to determine location from the signals received from the network client.

In a second mode, the network infrastructure may not implement any or very limited location determination functionality. For example, network access points may be ignorant of location enabled devices and/or are incapable of acting as readers with respect to location determination (e.g., incapable of determining the location of the devices/clients). In such a network environment, network clients (e.g., an RFID tag) may operate as readers, receiving transmissions from the access points from which location information is extracted. That is, the network client may be capable of determining its location from signals received from the network. For example, one or more of the network clients may perform RSSI measurements on transmissions received from various access points that are within range. The network client may then transmit this location information to, for example, location application 190 via standard communications with the wireless LAN. To facilitate location-awareness in a wide variety of wireless LAN environments, a network client that can operate in both environments may be desirable.

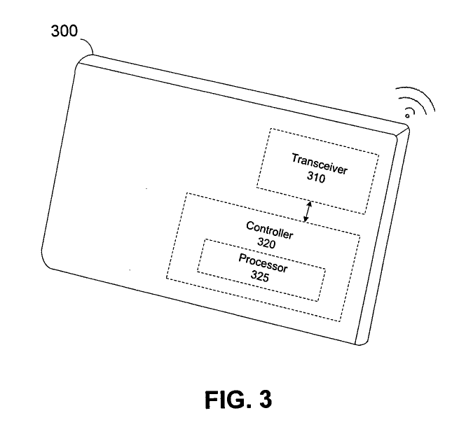

FIG. 3 illustrates an RFID tag having multi-mode functionality, in accordance with one embodiment of the present invention. RFID tag 300 includes transceiver 310 adapted to communicate with a wireless LAN, for example, wireless LAN 150, which may communicate using any standard, such as 802.11, Bluetooth, or any other wireless communication protocol. RFID 300 also includes a controller 320 having a processor 325 coupled to communicate with transceiver 310. Transceiver 310 and controller 320 may be integrated on the same chip or may be separate components. Processor 325 may be programmed to manipulate information received by transceiver 310 to compute, extract and/or obtain location information to facilitate determining the location of RFID tag 300, as described in further detail below.

When operating in a first mode (e.g., in a network environment having infrastructure that, to some extent, is location-aware), RFID tag 300 may be configured to transmit a chirp recognizable by the network. For example, RFID tag 300 may be similar to RFID tag 200 in this respect. That is, RFID tag 300 may include any one or combination of features described in connection with the RFID tag described in connection with FIG. 2. Alternatively, RFID tag 300 may transmit a chirp in any other format identifiable and recognizable by the network, for example, in non-802.11 networks.

When operating in a second mode (e.g., in a network environment where the infrastructure has little or no location-awareness, RFID tag 300 may be configured to receive signals from the wireless network (e.g., network access points) from which location information may be extracted. For example, signals received by transceiver 310 may be transferred to processor 325 for further analysis. For example, signals transmitted from various access points within range may be received and processed to obtain characteristics that facilitate computing the location of the tag.

In one embodiment, controller 320 includes a measurement component capable of obtaining RSSI measurements from signals received by transceiver 310. The RSSI measurements may then be used as location information (e.g., as an RF fingerprint) to facilitate determining the location of the device. Alternatively, the transceiver may perform measurements on the received signals. Controller 320 may package the location information in a standard communication packet and transfer the location information to transceiver 310 to be transmitted via the wireless network to one or more devices (e.g., location application 190) according to the communication standard by which the wireless network operates. For example, the RSSI measurements may be transmitted to the location application via the wireless network during a connectivity interval. Location application 190 may then analyze the location information to determine the location of the tag, for example, by matching the RF fingerprint to a fingerprint database, and display an icon of the tag on a visual interface provided by the application.

It should be appreciated that RFID tag 300 may be adapted to extract other measurements besides RSSI measurements to determine location, such as TDOA, TOA or AOA measurements, as the aspects of the invention are not limited in this respect. Moreover, the location information obtained by the RFID tag may be processed and analyzed in any manner, either at the RFID tag or by one or more devices connected to the network, as the aspects of the invention are not limited in this respect.

RFID tag 300 may be configured to operate in either mode, i.e., as a transmitter and/or as a reader. RFID tag 300 may be adapted such that the mode in which the tag operates can be configured either at the device or via the network. For example, one or more devices connected to the network may transmit instructions to the tag to operate in a particular mode. Location application 190, for instance, may include a program having a user interface that allows a user to set or toggle the mode in which the RFID tag operates.

In addition, RFID tag 300 may be configurable in any one or combination of ways described in connection with FIG. 2. For example, RFID tag 300 may be configured to operate in chirp mode only, or in combination with periodic network connectivity, wherein network access points operate as the readers. When operating in the mode in which the RFID tag operates as the reader, the RFID tag may associate with the network each time it transmits the obtained location information, or may be configured to operate using a separate interval to connect to the network to exchange configuration information, status updates, environmental conditions, etc.

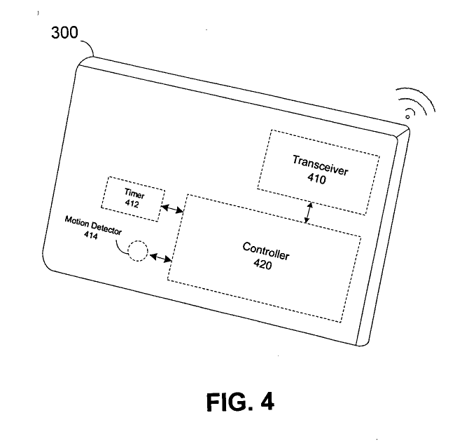

FIG. 4 illustrates an RFID tag capable of communicating wirelessly with a network to facilitate location awareness, in accordance with some embodiments of the present invention. RFID tag 400 may include any of the various components, features and/or functionality described in connection with RFID tags 200 and 300. In particular, RFID tag 400 may include a transceiver 410 for wirelessly exchanging information with the network. RFID tag may also include controller 420 configured to perform various computations, control various operations, and/or assist is carrying out various functionality of the RFID tag.

Controller 420 may include one or more processors and/or other circuitry adapted to perform one or more operations. The controller may be adapted to execute one or more software programs stored on a memory implemented as part of the controller (e.g., as part of one or more processors comprising the controller). The controller 420 may be configured to format communications with the network in a particular fashion to, for example, comply with the communication protocol of the network. For example, controller 420 may be configured to operate (e.g., transmit and receive data) as an 802.11 client on an 802.11 network (e.g., a WiFi® network.

Controller 420 may also be configured to interface with various other components of the RFID tag. For example, controller 420 may be coupled to timer 412 to coordinate transmitting a chirp at a desired rate, and/or configured to activate, deactivate and set a desired chirp rate. Controller 420 may also be coupled to motion detector 414 capable of sensing when the RFID tag is in motion, to implement motion triggered chirping. Controller 420 may be configured to activate or deactivate the motion detector such that chirps can be triggered by either the timer, the motion detector or both.

Controller 420 may also be configured to receive configuration information from the network to configure one or more properties of the RFID tag. For example, the configuration information may include a desired chirp rate, whether to use the timer, the motion detector or both as triggers for transmitting a chirp. The configuration information may include the format for a chirp. For example, the configuration information may select one of the 802.11 management frames to be used as the chirp for the RFID tag. The configuration information may indicate which mode the RFID tag should operate in, etc. The configuration information may include any other type of information regarding a configurable parameter of the RFID tag, as the aspects of the invention are not limited in this respect.

The controller may be configured to operate the RFID tag in a selected mode. For example, RFID tag 400 may be configured to operate in a plurality of modes as described above in connection with FIG. 3. In the first mode, the controller may be configured to transmit chirps that may be used by one or more components connected to the network to determine the location of the RFID tag. In the second mode, controller 420 may be configured to receive information, via the transceiver, from the network and process the information to determine the location of the RFID tag. For example, the controller may receive signals from a plurality of wireless access points arranged to provide wireless access to the network. The signal levels of the signals received from the plurality of access points may be used by the controller to form an RF fingerprint associated with the current location of the RFID tag. The RF fingerprint may then be compared to a database of RF fingerprints associated with respective locations, to determine an estimate of the location of the RFID tag. The signals received from the plurality of access points may be used in other ways to assist in determining an estimate of the location of the RFID tag, as the aspects of the invention are not limited in this respect.

As should be appreciated from the foregoing, there are numerous aspects of the present invention described herein that can be used independently of one another, including the aspects that relate to configurability and operating modes of a network client to be located. It should also be appreciated that in some embodiments, all of the above-described features can be used together, or any combination or subset of the features described above can be employed together in a particular implementation, as the aspects of the present invention are not limited in this respect. In addition, the various aspects of the invention may be applied to any network client and are not limited for use with RFID tags or any particular type of network client.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

It should be appreciated that the various methods outlined herein may be coded as software that is executable on one or more processors that employ any one of a variety of operating systems or platforms. Additionally, such software may be written using any of a number of suitable programming languages and/or conventional programming or scripting tools, and also may be compiled as executable machine language code. In this respect, it should be appreciated that one embodiment of the invention is directed to a computer-readable medium or multiple computer-readable media (e.g., a computer memory, one or more floppy disks, compact disks, optical disks, magnetic tapes, etc.) encoded with one or more programs that, when executed, on one or more computers or other processors, perform methods that implement the various embodiments of the invention discussed above. The computer-readable medium or media can be transportable, such that the program or programs stored thereon can be loaded onto one or more different computers or other processors to implement various aspects of the present invention as discussed above.

It should be understood that the term “program” is used herein in a generic sense to refer to any type of computer code or set of instructions that can be employed to program a computer or other processor to implement various aspects of the present invention as discussed above. Additionally, it should be appreciated that according to one aspect of this embodiment, one or more computer programs that, when executed, perform methods of the present invention need not reside on a single computer or processor, but may be distributed in a modular fashion amongst a number of different computers or processors to implement various aspects of the present invention.

Various aspects of the present invention may be used alone, in combination, or in a variety of arrangements not specifically discussed in the embodiments described in the foregoing, and the aspects of the present invention described herein are not limited in their application to the details and arrangements of components set forth in the foregoing description or illustrated in the drawings. The aspects of the invention are capable of other embodiments and of being practiced or of being carried out in various ways. Various aspects of the present invention may be implemented in connection with any type of network, cluster or configuration. No limitations are placed on the network implementation. Accordingly, the foregoing description and drawings are by way of example only.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

What is claimed is:

1. A dual mode radio frequency identification (RFID) tag adapted to facilitate location determination in a network, the RFID tag comprising:
a transceiver adapted to wirelessly exchange information with the network; and
a controller coupled to the transceiver, the controller configurable to operate the RFID tag in one of a plurality of modes,
wherein, in a first mode of the plurality of modes, the controller is configured to transmit a chirp to the network via the transceiver to be used by at least one network component to determine a location of the RFID tag, and
wherein, in a second mode of the plurality of modes, the controller is adapted to process information received from the network via the transceiver to compute a location of the RFID tag.

2. The RFID tag of claim 1, wherein the controller is configurable via the network by transmitting mode information indicative of one of the plurality of modes to the controller via the transceiver, such that when the controller receives the mode information, the controller operates in the mode indicated by the mode information.

3. The RFID tag of claim 1, wherein the controller is manually configurable to operate in any one of the plurality of modes.

4. The RFID tag of claim 1, wherein, in the second mode, the controller performs at least one radio signal strength indicator (RSSI) measurement on the information received from the network to determine the location of the RFID tag.

5. The RFID tag of claim 4, wherein, in the second mode, the information received from the network includes at least one signal from a plurality of access points, and wherein the controller is adapted to compute at least one radio frequency (RF) fingerprint from the at least one signal.

6. The RFID tag of claim 5, wherein the controller is configured to determine the location of the RFID tag based, at least in part, on the at least one RF fingerprint.

7. The RFID tag of claim 1, wherein, in the first mode, the controller transmits, via the transceiver, the chirp as an 802.11 management frame.

8. The RFID tag of claim 7, wherein, in the first mode, the controller transmits, via the transceiver, the chirp as an 802.11 probe request.

9. An 802.11 compliant radio frequency identification (RFID) tag adapted to facilitate location determination in a network environment, the RFID tag comprising:
a transceiver adapted to wirelessly transmit information to the network; and
a controller coupled to the transceiver, the controller adapted to transmit a chirp via the transceiver, to be used by at least one network component to determine, at least in part, a location of the RFID tag, wherein the controller is configured to transmit the chirp as an 802.11 management frame.

10. The RFID tag of claim 9, wherein the controller is configured to transmit the chirp as an 802.11 probe request.

11. The RFID tag of claim 10, wherein the controller is configured to operate the RFID tag in one of a plurality of modes, and wherein, in a first mode of the plurality of modes, the controller is configured to transmit the chirp to the network via the transceiver to be used by at least one network component to determine a location of the RFID tag, and wherein, in a second mode of the plurality of modes, the controller is adapted to process information received from the network via the transceiver to compute a location of the RFID tag.

12. A configurable radio frequency identification (RFID) tag to facilitate location determination in a network, the RFID tag comprising:
a transceiver adapted to wirelessly exchange information with the network; and
a controller coupled to the transceiver, the controller adapted to provide location information from which a location of the RFID tag may be determined, the controller configured to receive configuration information from at least one network component connected to the network and to configure at least one operating parameter of the RFID tag based on the configuration information.

13. The RFID tag of claim 1, 9 or 12, wherein the controller is adapted to transmit location information, via the transceiver, in a format understandable by at least one access point providing wireless access to the network.

14. The RFID tag of claim 13, further comprising a timer coupled to the controller, the timer having a programmable first interval of time, and wherein, when the timer is in operation, the controller transmits a chirp via the transceiver at the end of each first interval of time.

15. The RFID tag of claim 14, wherein the first interval of time may be programmed over the network by transmitting a desired first interval of time to the RFID tag via the transceiver, and wherein the controller is adapted to program the timer with the desired first interval of time.

16. The RFID tag of claim 13, further comprising a motion detector coupled to the controller, the motion detector configured to provide a motion signal to the controller upon detecting motion of the RFID tag, and wherein the controller is configured to transmit a chirp upon receiving the motion signal.

17. The RFID tag of claim 13, wherein the controller is adapted to periodically establish a connection with the network.

18. The RFID tag of claim 17, wherein the controller is adapted to perform an 802.11 association as part of establishing a connection with the network.

19. The RFID tag of claim 17, wherein the timer includes a programmable second interval of time, and wherein, when the timer is in operation, the controller is configured to establish a connection with the network at the end of each second interval of time.

20. The RFID tag of claim 17, wherein the controller is adapted to receive, via the transceiver, configuration information during intervals in which the RFID tag is connected to the network.

21. The RFID tag of claim 20, wherein the configuration information includes a chirp rate, and wherein the controller, upon receipt of the chirp rate, is configured to transmit chirps according to the chirp rate.

22. The RFID tag of claim 20, wherein the configuration information includes a connection rate, and wherein the controller, upon receipt of the connection rate, is configured to establish a connection with the network according to the connection rate.

23. The RFID tag of claim 20, further comprising a timer and a motion detector, and wherein the configuration information includes trigger information indicating whether to use the timer, the motion detector, or both as a trigger to transmit chirps, and wherein the controller is adapted to transmit chirps according to the trigger information.

24. The RFID tag of claim 20, wherein the controller is configured to transmit the chirp according to a plurality of formats, and wherein the configuration information includes a chirp format selection indicating which of the plurality of the formats the controller should transmit chirps, and wherein the controller, upon receipt of the chirp format selection, transmits chirps according to the selected format.

25. The RFID tag of claim 20, wherein the controller is configured to operate the RFID tag in one of a plurality of modes, and wherein, in a first mode of the plurality of modes, the controller is configured to transmit the chirp to the network via the transceiver to be used by at least one network component to determine a location of the RFID tag, and wherein, in a second mode of the plurality of modes, the controller is adapted to process information received from the network via the transceiver to compute a location of the RFID tag, and wherein the configuration information includes mode information indicating which of the plurality of modes to operate in, and wherein the controller, upon receipt of the mode information, operates the RFID tag in the selected mode.

26. The RFID tag of claim 13, further comprising at least one communications port configured to connect to an asset to which the RFID tag is affixed, and wherein the controller is adapted to exchange information between the asset and at least one network component connected to the network.
